(19) United States
(12) Patent Application Publication
(10) Pub. No.: US 2026/0346637 A1
(43) Pub. Date: Nov. 5, 2026

(54) ANTLER DISPLAY DEVICE

(71) Applicant: Skulli, LLC, Redding, CA (US)

(72) Inventors: Justin Pierson, Redding, CA (US); Chase D'Agostino, Bozeman, MT (US)

(73) Assignee: Skulli, LLC, Redding, CA (US)

(21) Appl. No.: 19/662,371

(22) Filed: Apr. 29, 2026

Related U.S. Application Data
(60) Provisional application No. 63/797,503, filed on Apr. 30, 2025.

(51) Int. Cl. B44C 5/06; F16M 13/02

(52) U.S. Cl. CPC B44C 5/06; F16M 13/02

(57) ABSTRACT

An antler display device includes a rail configured to be mounted to a surface, the rail comprising a tube having a plurality of keyhole fasteners formed therein, each keyhole fastener having an entry hole and a retention slot extending downwardly therefrom. The device also includes at least one ball-end retention assembly configured to secure an antler to the rail. The ball-end retention assembly comprises a cord having a first end and a second end, the cord configured to form a slipknot creating a loop around a burr portion of the antler, and a ball terminal connected to the first end of the cord at a ferrule, the ball terminal configured to engage with one of the plurality of keyhole fasteners to secure the antler to the rail.

### RELATED APPLICATIONS

This application claims priority to U.S. Provisional Patent Application No. 63/797,503, entitled ANTLER DISPLAY DEVICE and filed Apr. 30, 2025, hereby incorporated by reference in its entirety.

### FIELD OF THE INVENTION

The present invention relates to antler racks. More particularly, but not exclusively, the present invention relates to a storage and display rack for deer and elk antlers including sheds.

### BACKGROUND

Hunters and wildlife enthusiasts often collect antlers from deer, elk, and other cervids, either as shed antlers found in the wild or from harvested game animals. These antlers represent valuable trophies that many collectors wish to display prominently in their homes, cabins, or offices. Traditional methods for displaying antlers include wall-mounted plaques, taxidermy mounts, or simply placing them on shelves or tables. However, these conventional display methods present several limitations.

First, traditional display methods often fail to adequately showcase multiple antlers in a cohesive, organized manner. Wall plaques and taxidermy mounts typically accommodate only a single set of antlers, requiring significant wall space for displaying multiple specimens. Second, conventional display methods frequently lack adjustability, making it difficult to rearrange or reposition antlers once mounted. Third, many existing antler display solutions involve permanent or semi-permanent mounting, which can damage wall surfaces or the antlers themselves.

Furthermore, shed antler enthusiasts face particular challenges, as shed antlers lack the skull plate present in harvested trophies, making them difficult to mount using traditional methods. Collectors of shed antlers often resort to makeshift solutions such as tying them together with twine, placing them in baskets, or using adhesives to secure them to displays, none of which provide an elegant, adjustable solution.

Commercial shed antler display products on the market typically lack versatility, being designed for specific antler sizes or types. These products often do not allow for easy reconfiguration or expansion of the display as a collection grows. Additionally, many existing display systems are visually obtrusive, drawing attention to the mounting mechanism rather than showcasing the natural beauty of the antlers themselves.

Therefore, what is needed is a versatile, adjustable, and aesthetically pleasing system for displaying multiple antlers that accommodates various sizes and types of antlers, allows for easy reconfiguration, and provides a secure yet non-permanent mounting solution that preserves both the antlers and the mounting surface.

### SUMMARY

Therefore, it is a primary object, feature, or advantage of the present invention to improve over the state of the art.

It is a further object, feature, or advantage of the present invention to include a metal tube that has keyhole slots, mounts directly onto the wall or mounts using brackets and serves as the main anchor.

It is a still further object, feature, or advantage of the present invention to include a system using cable or cord with a cable ball stopper that acts as a locking mechanism.

Another object, feature, or advantage is that the paracord wraps around the burr of the antler using a slipknot and the cable ball inserts into one of the keyhole slots on the rail, securely hanging the antler in place.

Yet another object, feature, or advantage is that the loop length is adjustable allowing users to get the look and spacing they prefer.

It is a further object, feature, or advantage of the present invention to include a rail comprising a generally rectangular metal tube having a front face, with keyhole fasteners formed in the front face, such that cords of ball-end retention assemblies extend outwardly from the front face and hang downwardly therefrom, providing clearance between displayed antlers and a mounting surface and presenting antlers in a natural orientation with tines projecting outwardly away from the mounting surface.

It is a still further object, feature, or advantage of the present invention to include a slipknot that is oriented such that the gravitational load of a suspended antler acts in a tightening direction on the slipknot, causing the loop to cinch more tightly around the burr portion of the antler, thereby providing a self-tightening, load-responsive grip that automatically adjusts to accommodate antler burrs of varying sizes without requiring a new knot for each antler.

It is a further object, feature, or advantage of the present invention that the adjustable loop of each ball-end retention assembly is formed by an adjustable cinch. As used herein, the term "adjustable cinch" refers to any device, knot, or fastener that creates an adjustable loop in the cord and that permits the size of the loop to be increased or decreased. The adjustable cinch may comprise, without limitation, a hand-tied slipknot, a sliding cinch such as a barrel clasp, a spring-loaded cord lock, or a friction clamp through which two legs of the cord pass, or any other cinching device that creates an adjustable loop capable of tightening around the burr portion of an antler under gravitational loading.

Another object, feature, or advantage is that the loop of each ball-end retention assembly encircles the burr portion of an antler, wherein the enlarged diameter of the burr relative to the main beam of the antler acts as a natural mechanical stop that prevents the loop from migrating along the main beam and slipping off the antler, and wherein the irregular surface texture of the burr provides frictional engagement with the cord that resists rotation or slippage, thereby exploiting the natural geometry of the antler as an integral retention feature without requiring adhesives, clamps, screws, or other fasteners that could damage the antler.

Yet another object, feature, or advantage is that the cord of each ball-end retention assembly extends through a ferrule and through the ball terminal and terminates in a knot on a side of the ball terminal opposite the ferrule, such that the ferrule and the knot provide a dual-retention arrangement that prevents the cord from separating from the ball terminal under sustained gravitational loading of heavy antlers.

It is a further object, feature, or advantage of the present invention to include a decorative cutout formed in the front face of the rail, which serves both an aesthetic function complementing the displayed antlers and a functional role as a visual orientation reference during installation, enabling the user to confirm proper orientation and leveling of the rail by verifying that the imagery depicted in the decorative cutout is upright, which in turn ensures that the keyhole fasteners are correctly oriented with entry holes at top and retention slots extending downwardly for proper gravity-assisted retention of the ball terminals.

Another object, feature, or advantage is that the decorative cutout and the plurality of keyhole fasteners may be formed in the front face of the generally rectangular metal tube in a single manufacturing operation, such as laser cutting or plasma cutting, reducing manufacturing complexity.

Yet another object, feature, or advantage is that the rail may further comprise end caps on opposite ends of the generally rectangular metal tube, providing a finished appearance and protecting the interior of the tube from debris or moisture.

It is a further object, feature, or advantage of the present invention that the ball terminal has a diameter greater than a width of the retention slot and less than or equal to a diameter of the entry hole, such that the ball terminal passes freely through the entry hole and is retained within the retention slot under the gravitational load of the suspended antler, providing gravity-assisted retention that secures each antler during normal use without requiring secondary fasteners while still permitting intentional removal by lifting the cord upwardly to realign the ball terminal with the entry hole.

Another object, feature, or advantage is that at least two of the plurality of ball-end retention assemblies may have loops of different lengths such that respective antlers are suspended at different heights relative to the rail, enabling a visually varied display arrangement that accommodates antlers of different sizes including deer antlers, elk antlers, and shed antlers.

It is a further object, feature, or advantage of the present invention that the ball terminal may take various forms including a spherical ball, a bead lock having an upper portion, a neck, and a flange, or other shaped terminal element, each configured to be inserted through the entry hole of a keyhole fastener and retained within the retention slot, such that the term "ball terminal" as used herein encompasses any terminal element having a dimension greater than the width of the retention slot that prevents the terminal element from passing through the retention slot under gravitational loading.

It is a still further object, feature, or advantage of the present invention that the slipknot may be formed by hand-tying the cord in a conventional slipknot configuration or by a sliding cinch through which two legs of the cord pass, the sliding cinch being slidable along the cord to adjust the size of the loop, such that the term "slipknot" as used herein encompasses any adjustable cinching mechanism that creates a loop capable of tightening around the burr portion of an antler under gravitational loading.

One or more of these and/or other objects, features, or advantages of the present invention will become apparent from the specification and claims that follow. No single embodiment need provide each and every object, feature, or advantage. Different embodiments may have different objects, features, or advantages. Therefore, the present invention is not to be limited to or by any objects, features, or advantages stated herein.

According to one aspect, an antler display device includes a rail configured to be mounted to a surface, the rail comprising a tube having a plurality of keyhole slots formed therein. The device also includes at least one loop system configured to secure an antler to the rail. The loop system comprises a cord having a first end and a second end, the cord configured to form a slipknot around a burr portion of the antler, and a stopper connected to the first end of the cord. The stopper is configured to engage with one of the plurality of keyhole slots to secure the antler to the rail. The loop system allows for adjustable positioning and spacing of multiple antlers along the rail, providing an efficient and customizable display solution. The rail may be configured to be mounted directly to a wall such as being configured to be mounted to a wall using at least one bracket. The cord may be a paracord. The stopper may be a cable ball stopper. The loop system may be adjustable in length such that the adjustability of the loop system allows for customized spacing between multiple antlers mounted on the rail. The plurality of keyhole slots may be arranged linearly along the length of the rail. The tube may be a metal tube.

According to another aspect, a method for displaying an antler includes providing a rail comprising a metal tube having a plurality of keyhole slots formed therein, mounting the rail to a surface, forming a slipknot with a cord around a burr portion of an antler, and inserting a stopper connected to the cord into one of the plurality of keyhole slots to secure the antler to the rail. The method may further include adjusting the length of the cord to achieve a desired positioning of the antler relative to the rail. The method may further include securing a plurality of antlers to the rail using a plurality of loop systems.

According to yet another aspect, an antler display system includes a rail formed from a metal tube having a plurality of keyhole slots formed therein. The antler display system further includes a plurality of loop systems, each loop system may include a cord configured to form a slipknot around a burr portion of an antler and a stopper attached to the cord, the stopper configured to engage with one of the plurality of keyhole slots in the rail. Each loop system may be independently adjustable in length to allow customization of the spacing and positioning of multiple antlers displayed on the rail. The rail may be mountable directly to a wall or via at least one bracket.

According to another aspect, an antler display device includes a rail configured to be mounted to a surface, the rail comprising a tube having a plurality of keyhole fasteners formed therein. The device also includes at least one ball-end retention assembly configured to secure an antler to the rail. The ball-end retention assembly comprises a cord having a first end and a second end, the cord configured to form a slipknot creating a loop around a burr portion of the antler, and a ball terminal connected to the first end of the cord at a ferrule, the ball terminal configured to engage with one of the plurality of keyhole fasteners to secure the antler to the rail. The rail may be configured to be mounted directly to a wall or may be configured to be mounted to a wall using at least one bracket. The cord may comprise paracord. The loop may be adjustable in length, wherein the adjustability of the loop may allow for customized spacing between multiple antlers mounted on the rail. The plurality of keyhole fasteners may be arranged linearly along the length of the rail. The retention slot may have a width less than the diameter of the entry hole. Decorative elements may be provided on the rail between adjacent keyhole fasteners. The rail may be formed of metal.

According to another aspect, a method for displaying an antler includes providing a rail comprising a metal tube having a plurality of keyhole fasteners formed therein, mounting the rail to a surface, forming a slipknot with a cord around a burr portion of an antler, creating a loop that encircles the antler, inserting a ball terminal connected to the cord into an entry hole of one of the plurality of keyhole fasteners, and positioning the cord in a retention slot of the keyhole fastener such that the ball terminal is retained within the retention slot to secure the antler to the rail. The method may further include adjusting the length of the loop to achieve a desired positioning of the antler relative to the rail. The method may further include securing a plurality of antlers to the rail using a plurality of ball-end retention assemblies. The rail may be mounted directly to a wall or may be mounted to a wall using at least one bracket.

According to yet another aspect, an antler display system includes a rail comprising a metal tube having a plurality of keyhole fasteners formed therein. The system also includes a plurality of ball-end retention assemblies, each assembly comprising a cord configured to form a slipknot creating a loop around a burr portion of an antler, and a ball terminal attached to the cord by a ferrule, the ball terminal configured to engage with one of the plurality of keyhole fasteners in the rail. Each loop may be independently adjustable in length to allow customization of the spacing and positioning of multiple antlers displayed on the rail. The rail may be mountable directly to a wall or via at least one bracket. The cord may include paracord. Decorative elements may be provided on the rail between adjacent keyhole fasteners. The system may be configured to display deer or elk antlers, including shed antlers.

According to another aspect, an antler display device for displaying a plurality of antlers includes a rail configured to be mounted to a surface, the rail comprising a generally rectangular metal tube having a front face, the front face having a plurality of keyhole fasteners formed therein, each keyhole fastener having an entry hole and a retention slot extending downwardly therefrom. The device also includes a plurality of ball-end retention assemblies, each ball-end retention assembly configured to secure a respective one of the plurality of antlers to the rail. Each ball-end retention assembly comprises a cord having a first end and a second end, the cord configured to form a slipknot creating a loop sized to encircle a burr portion of the respective one of the plurality of antlers, and a ball terminal connected to the first end of the cord at a ferrule, the ball terminal configured to engage with one of the plurality of keyhole fasteners to secure the respective one of the plurality of antlers to the rail. The rail may be configured to be mounted directly to a wall or to a wall using at least one bracket. The cord of each ball-end retention assembly may comprise paracord. The loop of each ball-end retention assembly may be independently adjustable in length to accommodate antlers of different sizes among the plurality of antlers and to allow for customized spacing between the plurality of antlers mounted on the rail. The plurality of keyhole fasteners may be arranged linearly along the front face of the rail and each retention slot may have a width less than the diameter of the respective entry hole. The cords of the plurality of ball-end retention assemblies may extend outwardly from the front face and hang downwardly therefrom such that the plurality of antlers hang in a plane spaced apart from and generally parallel to a mounting surface, and positioning the keyhole fasteners on the front face may provide clearance between the plurality of antlers and the mounting surface. The device may further comprise a decorative cutout formed in the front face of the rail, wherein the decorative cutout and the plurality of keyhole fasteners are visible to a viewer when the rail is mounted to a surface. The rail may further comprise end caps on opposite ends of the generally rectangular metal tube. The slipknot of each ball-end retention assembly may be oriented such that a gravitational load of the respective one of the plurality of antlers acts in a tightening direction on the slipknot, causing the loop to cinch more tightly around the burr portion of the respective one of the plurality of antlers as the respective one of the plurality of antlers hangs from the rail. The burr portion of each of the plurality of antlers may have an enlarged diameter relative to a main beam of the respective one of the plurality of antlers, and the loop of each ball-end retention assembly may encircle the burr portion such that the enlarged diameter of the burr portion prevents the loop from migrating along the main beam of the respective one of the plurality of antlers. The cord of each ball-end retention assembly may extend through the ferrule and through the ball terminal and terminate in a knot on a side of the ball terminal opposite the ferrule, such that the ferrule and the knot cooperate to prevent the cord from separating from the ball terminal under gravitational loading of the respective one of the plurality of antlers.

According to another aspect, an antler display device for displaying a plurality of antlers includes a rail comprising a generally rectangular metal tube having a front face, a plurality of keyhole fasteners formed in the front face, each keyhole fastener having an entry hole and a retention slot extending downwardly therefrom, and a decorative cutout formed in the front face, the decorative cutout depicting outdoors-themed imagery. The device also includes a plurality of ball-end retention assemblies, each ball-end retention assembly configured to secure a respective one of the plurality of antlers to the rail. Each ball-end retention assembly comprises a cord having a first end and a second end, the cord configured to form a slipknot creating an adjustable loop sized to encircle a burr portion of the respective one of the plurality of antlers, the slipknot oriented such that a gravitational load of the respective one of the plurality of antlers acts in a tightening direction on the slipknot, and a ball terminal connected to the first end of the cord at a ferrule, the ball terminal having a diameter greater than a width of the retention slot and less than or equal to a diameter of the entry hole, the ball terminal configured to be inserted through the entry hole and retained within the retention slot to secure the respective one of the plurality of antlers to the rail. The cords of the plurality of ball-end retention assemblies extend outwardly from the front face and hang downwardly therefrom such that the plurality of antlers hang spaced apart from a mounting surface. The rail may be configured to be mounted directly to a wall or to a wall using at least one bracket. The cord of each ball-end retention assembly may comprise paracord. At least two of the plurality of ball-end retention assemblies may have adjustable loops of different lengths such that respective ones of the plurality of antlers are suspended at different heights relative to the rail. The burr portion of each of the plurality of antlers may have an enlarged diameter relative to a main beam of the respective one of the plurality of antlers, and the loop of each ball-end retention assembly may encircle the burr portion such that the enlarged diameter of the burr portion prevents the loop from migrating along the main beam of the respective one of the plurality of antlers. The cord of each ball-end retention assembly may extend through the ferrule and through the ball terminal and terminate in a knot on a side of the ball terminal opposite the ferrule, such that the ferrule and the knot cooperate to prevent the cord from separating from the ball terminal under gravitational loading of the respective one of the plurality of antlers. The decorative cutout and the plurality of keyhole fasteners may be formed in the front face in a single manufacturing operation. The plurality of antlers may comprise deer antlers, elk antlers, shed antlers, or combinations thereof, each secured to the rail by a respective one of the plurality of ball-end retention assemblies with the loop of the respective ball-end retention assembly cinched around the burr portion of the respective one of the plurality of antlers such that each of the plurality of antlers hangs downwardly from the rail with tines of each of the plurality of antlers projecting outwardly away from the mounting surface.

### BRIEF DESCRIPTION OF THE DRAWINGS

Illustrated embodiments of the disclosure are described in detail below with reference to the attached drawing figures, which are incorporated by reference herein.

FIG. 1 is a pictorial representation of the antler display device.

FIG. 2 illustrates the antler display device with two keyholes.

FIG. 3 illustrates a cord.

FIG. 4 illustrates the antler display device with eighteen keyholes.

FIG. 5 illustrates the antler display device with twelve keyholes.

FIG. 6 illustrates the cord.

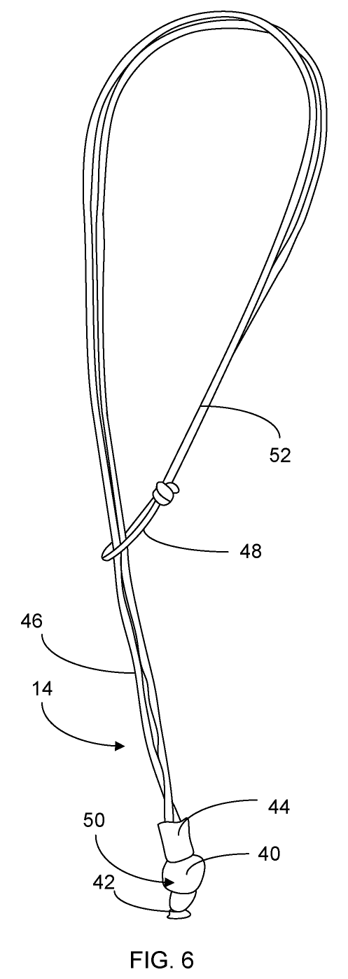

FIG. 7 illustrates one example of the ball terminal in a form of a bead lock.

FIG. 8 illustrates one example of the slip knot in the form of a sliding cinch.

### DETAILED DESCRIPTION

The current invention is a storage and display solution for deer and elk antlers, especially designed specifically with the needs of shed hunters and the hunting industry in mind.

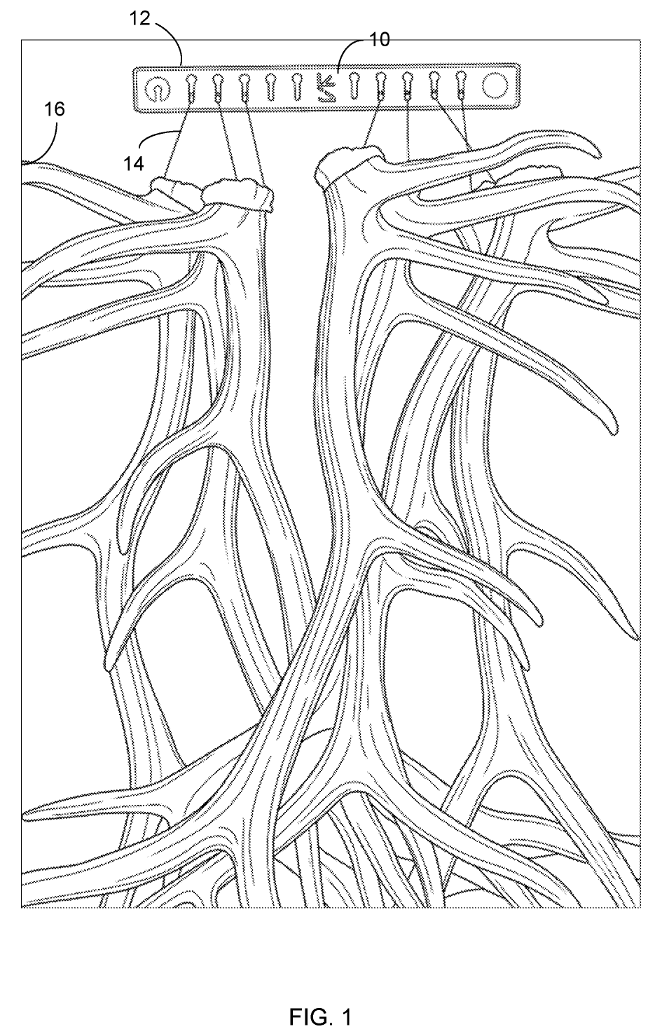

FIG. 1 illustrates the antler display device 10. As shown in FIG. 1, the antler display device 10 has a rail 12. Ball-ended cords 14 extend downwardly from the rail 12 to support antler 16. The antler display 10 may be mounted to a wall in any number of ways. The display of antlers, especially shed antlers in this fashion is particularly aesthetic in that it allows for multiple antlers to be displayed at the same time. Although shed antlers are shown it is to be understood that antlers from hunted game may also display in which case instead of rounded ends, portions of the skull cap may be present.

The antler display device 10 may be sized to accommodate different numbers of antlers based on the number and spacing of keyhole fasteners present, the function of which will be explained later herein.

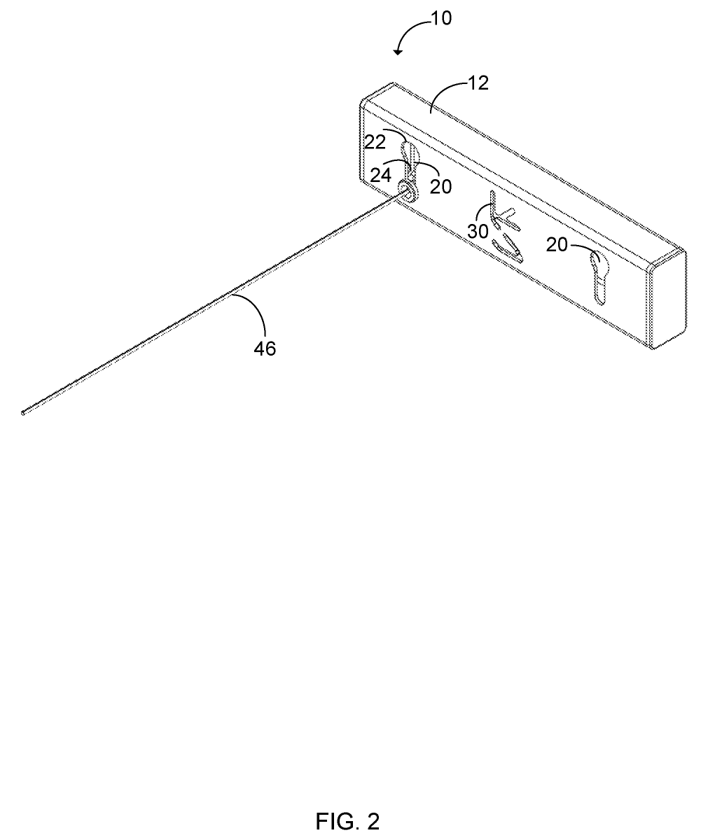

FIG. 2 illustrates an example of the antler display device 10 where two keyhole fasteners 20 are present. Each keyhole fastener 20 is oriented with a larger generally circular opening at top which serves as an entry hole 22 and a retention slot 24 of a width less than the diameter of the entry hole 22 extending downwardly therefrom. The retention slot 24 may have a longitudinal axis in alignment with a longitudinal axis of the entry hole such that the retention slot 24 is centered relative to the entry hole 22. A cord 46 is shown extending from one of the keyhole fasteners 20. Where multiple keyholes fasteners 20 are present they may be spaced apart from each other. In some embodiments, space between keyhole fasteners 20 may be used to include logos, text, or other decorative elements 30. In some embodiments the rail 12 may be formed of metal and the decorative elements 30 may be cut into the rail 12, etched into the rail or otherwise provided.

Thus, the antler display device 10 includes the rail 12 with the keyhole fasteners 20. The rail 12 may be formed from a metal tube and may also include end caps on opposite sides. The rail 12 may be configured to mount directly to a wall or may be configured for mounting using brackets or other fasteners. The rail 12 may function as the main anchor point for hanging the antlers.

In certain embodiments, the keyhole fasteners 20 and the decorative element 30 are each formed in a front face of the rail 12. The front face is the face of the generally rectangular metal tube that faces outwardly away from the mounting surface when the rail 12 is mounted to a wall or other surface. By locating the keyhole fasteners 20 on the front face, the cords of the ball-end retention assemblies extend outwardly from the front face and hang downwardly therefrom, allowing the plurality of antlers to hang in a plane spaced apart from and generally parallel to the mounting surface. This configuration provides clearance between the antlers and the mounting surface, potentially reducing the contact between the antlers and the wall. Additionally, the front-face orientation of the keyhole fasteners 20 positions the entry holes 22 and retention slots 24 in full view of the user, facilitating easy insertion and removal of the ball terminals when reconfiguring the display.

Positioning the decorative element 30 on the front face of the rail 12 ensures that the decorative element 30 is visible to a viewer when the rail 12 is wall-mounted, rather than being obscured by the mounting surface or by the antlers themselves. Because the decorative element 30 is a cutout formed in the same front face as the keyhole fasteners 20, the decorative element 30 and the keyhole fasteners 20 may be formed in a single manufacturing operation, such as laser cutting or plasma cutting, reducing manufacturing complexity. The decorative element 30 may depict an antler silhouette, a logo, text, or other outdoors-themed imagery, providing an aesthetic complement to the displayed antlers.

The decorative cutout 30 formed in the front face of the rail 12, in addition to providing an aesthetic complement to the displayed antlers, serves a functional role as a visual orientation reference during installation. Because the decorative cutout 30 depicts recognizable logo or outdoors-themed imagery, the user can visually confirm that the imagery is upright and properly oriented during mounting of the rail 12 to a wall or other surface, which in turn confirms that the keyhole fasteners 20 are correctly oriented with the entry holes 22 at top and the retention slots 24 extending downwardly. Proper orientation of the keyhole fasteners 20 is used for the gravity-assisted retention function of the ball terminals 40, as an inverted or misaligned keyhole fastener 20 would not retain the ball terminal 40 under the weight of a suspended antler. The decorative cutout 30 thus provides a quick and intuitive installation aid that reduces the likelihood of improper mounting.

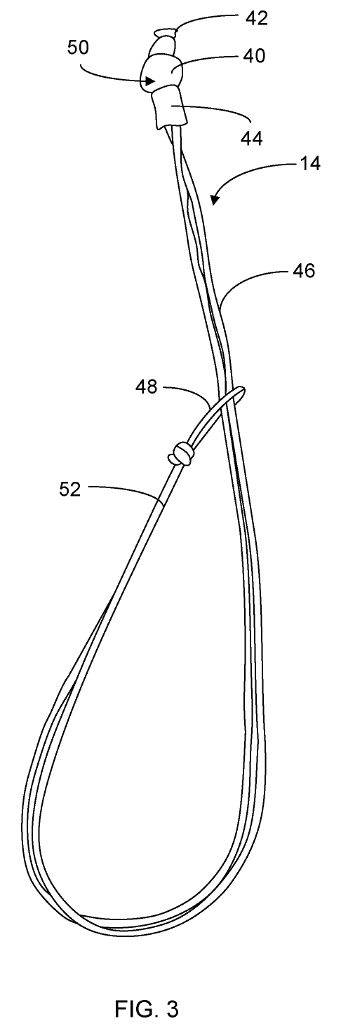

FIG. 3 illustrates a cord in more detail. Note that the cord 14 terminates at top with a ball end retention assembly 50. The purpose of the ball is to position within a top portion of the keyhole. Upon pulling the cord downwardly into a keyhole, although the cord fits through the slot portion of the keyhole, the ball does not. Thus, the cord is secure within the keyhole unless the ball is pulled upwardly to the top of the keyhole. Doing so involves intentional action and force so that in normal use, there is no inadvertent disconnection from the rail. Thus, the ball functions as a locking mechanism.

The ball-end retention assembly 14 includes a cord 46 which terminates by extending through a ferrule 44 and through a ball terminal 40 where the cord 46 may be configured into a knot 42 for retention. On the opposite end of the cord, a slip knot 48 may be present. In this manner the cord 46 includes a loop 52 which may encircle an end of an antler to secure the antler in place and allow it to hang from the cord 46 of the ball-end-retention assembly 14.

The ferrule 44 serves as a mechanical connection between the cord 46 and the ball terminal 40. In the illustrated embodiment, the cord 46 extends through the ferrule 44 and through a bore in the ball terminal 40, where the cord 46 is configured into a knot 42 on a distal side of the ball terminal 40 opposite the ferrule 44. The ferrule 44 may be a crimp fitting, a compression sleeve, or a swaged collar that is deformed around the cord 46 to grip the cord 46 and prevent the cord 46 from pulling through the ball terminal 40 under load. In this manner, the ferrule 44 acts as a primary load-bearing connection point, and the knot 42 acts as a secondary or redundant retention feature. This dual-retention arrangement is particularly advantageous for antler display because antlers can be heavy with mature elk antlers, for example, weighing several pounds and the combined retention of the ferrule 44 and the knot 42 ensures that the cord 46 does not slip through or separate from the ball terminal 40 under sustained gravitational loading. The ferrule 44 may be formed of metal, such as aluminum, brass, or steel, and may be selected to complement the aesthetic of the rail 12 and the displayed antlers.

The slipknot 48 is configured such that the gravitational load of the antler suspended from the cord 46 acts in a direction that tightens the slipknot 48 around the burr portion of the antler. Specifically, the running end of the slipknot 48 extends upwardly from the loop 52 toward the rail 12, so that the downward gravitational force exerted by the weight of the antler on the loop 52 pulls the running end of the slipknot 48 in the tightening direction, causing the loop 52 to cinch more tightly around the burr portion. The heavier the antler, the greater the cinching force and the more securely the loop 52 grips the burr portion. This self-tightening behavior under gravitational load is in contrast to a fixed-diameter loop or a tied knot of fixed circumference, either of which could allow the antler to shift, rotate, or slide out of the loop 52 if the loop diameter does not precisely match the circumference of the burr portion. Because antler burrs vary in size from specimen to specimen ranging from relatively small burrs on young whitetail deer antlers to large, heavily textured burrs on mature elk antlers, the self-tightening slipknot 48 automatically adjusts its grip to accommodate these variations without requiring the user to tie a new knot for each antler. This self-adjusting, load-responsive grip is a significant advantage over fixed-loop or adhesive-based antler mounting solutions.

The loop 52 of each ball-end retention assembly 14 is configured to encircle the antler at or adjacent to the burr portion because the burr provides a natural mechanical stop that prevents the loop 52 from migrating along the length of the antler and slipping off. The burr of an antler is the rough, knobby, annular protrusion located at the base of the antler where it was attached to the pedicle of the animal's skull. The burr has an enlarged diameter relative to the main beam of the antler above it, and often features an irregular, textured surface with ridges, bumps, and rough projections. When the loop 52 is cinched around the burr portion by the slipknot 48, the enlarged diameter of the burr relative to the main beam above prevents the loop 52 from sliding upward along the main beam and off the antler, while the irregular surface texture of the burr provides frictional engagement with the cord 46 that resists rotation or slippage of the loop 52 around the circumference of the burr. In this manner, the antler display device 10 exploits the natural geometry and surface characteristics of the antler burr as an integral retention feature of the system, without requiring adhesives, clamps, screws, or other fasteners that could damage the antler. For shed antlers, the base of the antler below the burr presents a generally concave or irregular surface where the antler separated from the pedicle, and this base surface in combination with the burr creates a natural channel or seat in which the loop 52 rests securely. For antlers from harvested game that include a portion of the skull plate, the loop 52 may similarly encircle the burr or the base of the antler adjacent to the skull plate, with the skull plate itself providing an additional stop against upward migration of the loop 52.

The cord 46 may be made of any number of materials including nylon, metal cable, flexible wire, paracord, plastic cable, or otherwise. The cord 46 may wrap around the burr of the antler using a slip knot, and the ball inserts into one of the keyhole slots on the rail. This securely hangs the antler in place. The loop length of the loop 52 is adjustable, so users can get the look or spacing they want. Multiple antlers may be hung on a single rail, making this a space-efficient and clean-looking solution for antler storage or display.

The slipknot 48 of each ball-end retention assembly 14 may be formed by hand-tying the cord 46 in a conventional slipknot configuration, or alternatively may be formed using a sliding cinch. The sliding cinch is a mechanical fastener through which two legs of the cord 46 pass, the sliding cinch being slidable along the cord 46 to adjust the size of the loop 52 formed below the sliding cinch. The sliding cinch may be a barrel clasp, a spring-loaded cord lock, a friction clamp, or other mechanical device that grips the two legs of the cord 46 and holds them in a fixed relative position until the user intentionally repositions the sliding cinch. As used herein, the term "slipknot" encompasses both a hand-tied slipknot and a slipknot formed by a sliding cinch or other mechanical cinching device, as both achieve the same functional result of creating an adjustable loop 52 that cinches around the burr portion of an antler and that tightens under the gravitational load of the suspended antler. The sliding cinch may provide certain advantages over a hand-tied slipknot, including more precise and repeatable adjustment of the loop size, reduced likelihood of the knot loosening over time under sustained loading, and ease of adjustment by the user when reconfiguring the display. The sliding cinch may be formed of metal, polymer, or other durable material and may be selected to aesthetically complement the rest of the device. When the gravitational load of the suspended antler acts on the loop 52, the two legs of the cord 46 are drawn upwardly through the sliding cinch in the tightening direction, causing the loop 52 to cinch more tightly around the burr portion of the antler in the same self-tightening manner as described with respect to a hand-tied slipknot.

The adjustable loop 52 of each ball-end retention assembly 14 is formed by an adjustable cinch. As used herein, the term "adjustable cinch" encompasses any device, knot, or fastener that creates an adjustable loop in the cord 46 and that permits the size of the loop 52 to be increased or decreased by the user. In one embodiment, the adjustable cinch comprises a hand-tied slipknot, in which the cord 46 is tied such that pulling a running end of the cord 46 tightens or loosens the loop 52. In another embodiment, the adjustable cinch comprises a sliding cinch, which is a mechanical fastener through which two legs of the cord 46 pass, the sliding cinch being slidable along the cord 46 to adjust the size of the loop 52. Other forms of adjustable cinch are contemplated, including but not limited to toggle clamps, cam cleats, and other cordage hardware that permit adjustable loop formation. Regardless of the specific form, the adjustable cinch is configured such that the gravitational load of a suspended antler acts in a tightening direction, causing the adjustable loop 52 to cinch more tightly around the burr portion of the antler.

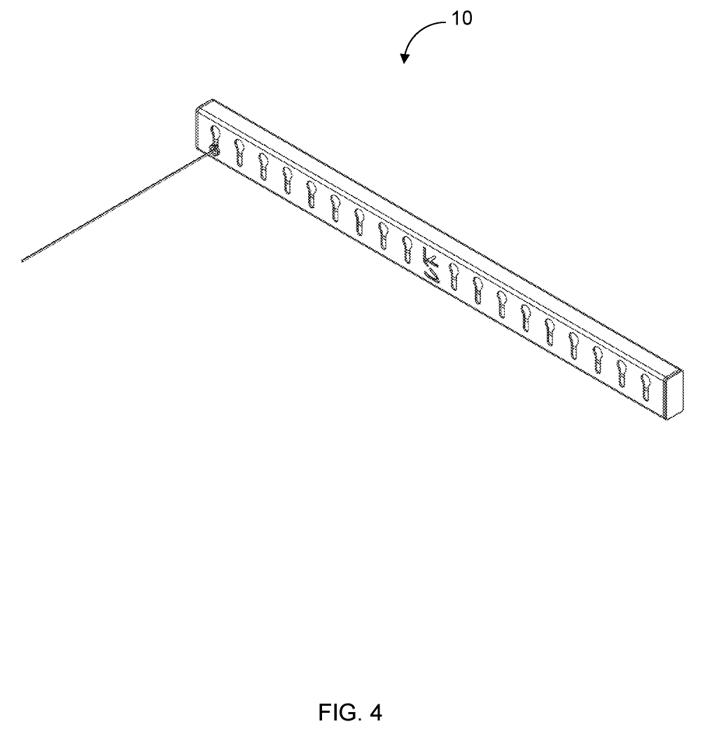

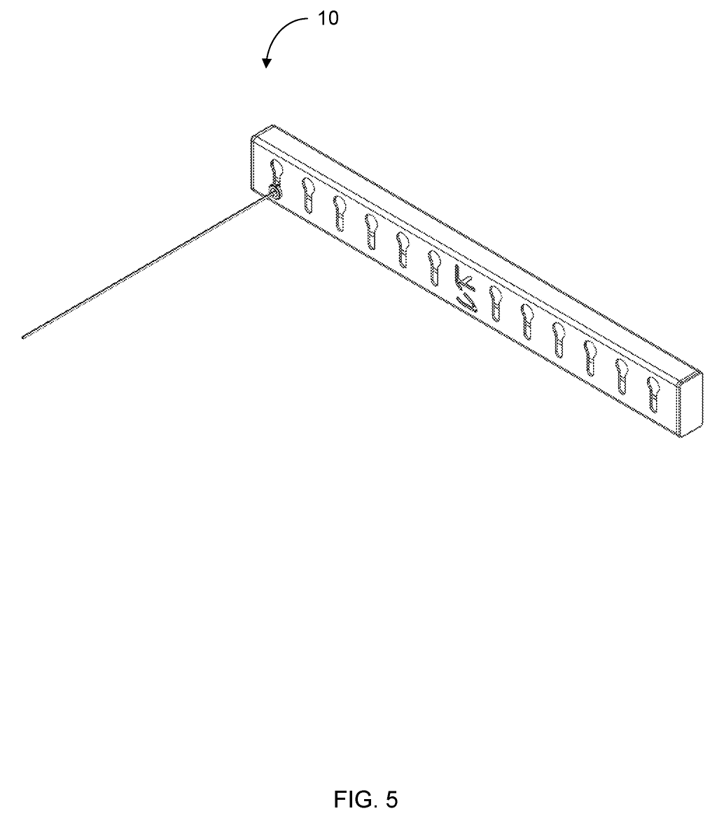

As previously explained, the antler display device 10 may be sized to accommodate different numbers of antlers. FIG. 4 illustrates a display device 10 with eighteen keyholes present. FIG. 5 illustrates a display device 10 with twelve keyholes present. It should be understood that the greater the number of keyholes present, the greater the weight which the display device 10 may be configured to support. Therefore, the antler display device 10 may be secured to a wall or other structure in different ways whether directly, through the use of mounting brackets, braces, hangers, or otherwise.

When securing an antler to the rail 12, the user positions the ball terminal 40 at the entry hole 22 of one of the keyhole fasteners 20 and inserts the ball terminal 40 through the entry hole 22. Because the ball terminal 40 has a diameter less than or equal to the diameter of the entry hole 22, the ball terminal 40 passes freely through the entry hole 22 into the interior of the tube. The weight of the antler suspended from the cord 46 then draws the cord 46 downwardly into the retention slot 24, which has a width less than the diameter of the ball terminal 40. The ball terminal 40 thereby seats against an interior surface of the front face of the tube adjacent to the retention slot 24, and the weight of the suspended antler maintains the ball terminal 40 in the retained position. This gravity-assisted retention ensures that the antler remains securely hung during normal use without requiring any secondary fasteners or locking hardware, while still permitting intentional removal by lifting the cord 46 upwardly to realign the ball terminal 40 with the entry hole 22. This arrangement is particularly suited to antler display because antlers are heavy, asymmetrically weighted objects whose gravitational load naturally and continuously biases the ball terminal 40 into the locked position within the retention slot 24.

The positioning of the keyhole fasteners 20 on the front face of the generally rectangular metal tube is particularly advantageous for displaying antlers because antlers are irregularly shaped objects having tines that project in multiple directions from a central beam. By suspending each antler from the front face of the rail 12, the antler hangs in a plane spaced apart from and generally parallel to the mounting surface, with the tines of each antler projecting outwardly, laterally, and downwardly away from the mounting surface rather than pressing against or scraping the wall. This is in contrast to configurations where hanging elements are positioned on a top face or bottom face of a mounting rail, which would cause the antler to hang directly against or in close proximity to the wall, resulting in potential damage to both the wall surface and the antler tines. The front-face suspension configuration thus assists in preserving both the antlers and the mounting surface while presenting each antler in a natural, visually appealing orientation.

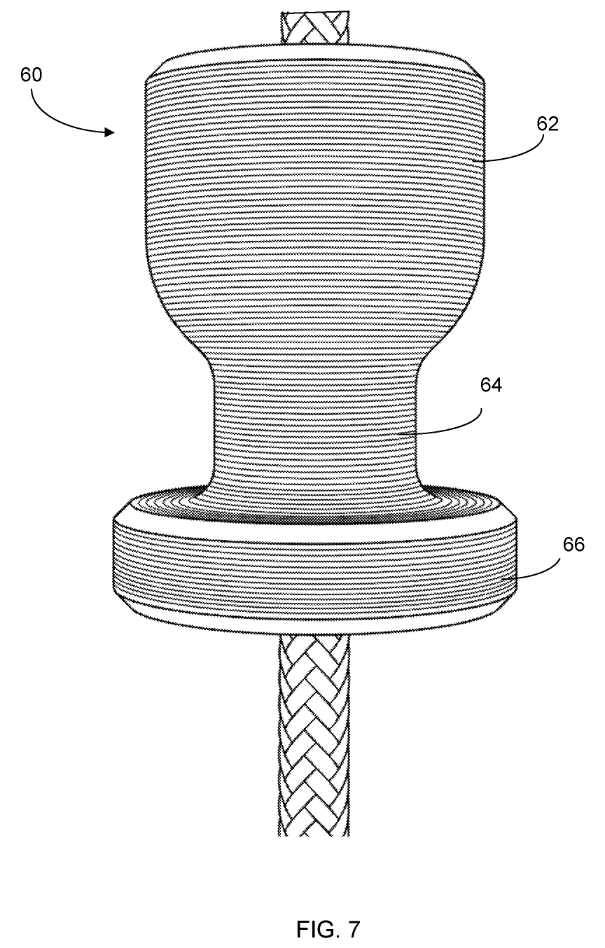

FIG. 7 illustrates a bead lock 60 in detail. The bead lock 60 is an alternative embodiment of the ball terminal 40 and may be used interchangeably therewith as part of the ball-end retention assembly 14. The bead lock 60 has a multi-part profile comprising an upper portion 62, a neck 64, and a flange 66. The upper portion 62 has a generally cup-shaped or chalice-shaped profile and includes a bore through which the cord 46 extends and exits from a top of the upper portion 62, where the cord 46 may be configured into a knot 42 for retention. The neck 64 extends downwardly from the upper portion 62 and has a reduced diameter relative to both the upper portion 62 and the flange 66. The flange 66 extends radially outwardly from a lower end of the neck 64 and has a diameter greater than the width of the retention slot of the keyhole fastener. In use, the upper portion 62 and the flange 66 are inserted through the entry hole, and the cord is then drawn downwardly such that the neck 64 seats within the retention slot. In this position, the flange 66 bears against an interior surface of the front face of the rail below the retention slot , and the upper portion 62 bears against an interior surface of the front face above the retention slot, such that the bead lock 60 is captured on opposite sides of the front face at the retention slot. The flange 66 distributes the gravitational load of the suspended antler across a wider area of the interior surface of the front face than a spherical ball terminal, reducing stress concentration at the retention slot. The reduced diameter of the neck 64 relative to the flange 66 and the upper portion 62 prevents the bead lock 60 from passing through the retention slot, providing secure retention under gravitational loading while permitting intentional removal by lifting the bead lock 60 upwardly to realign with the entry hole.

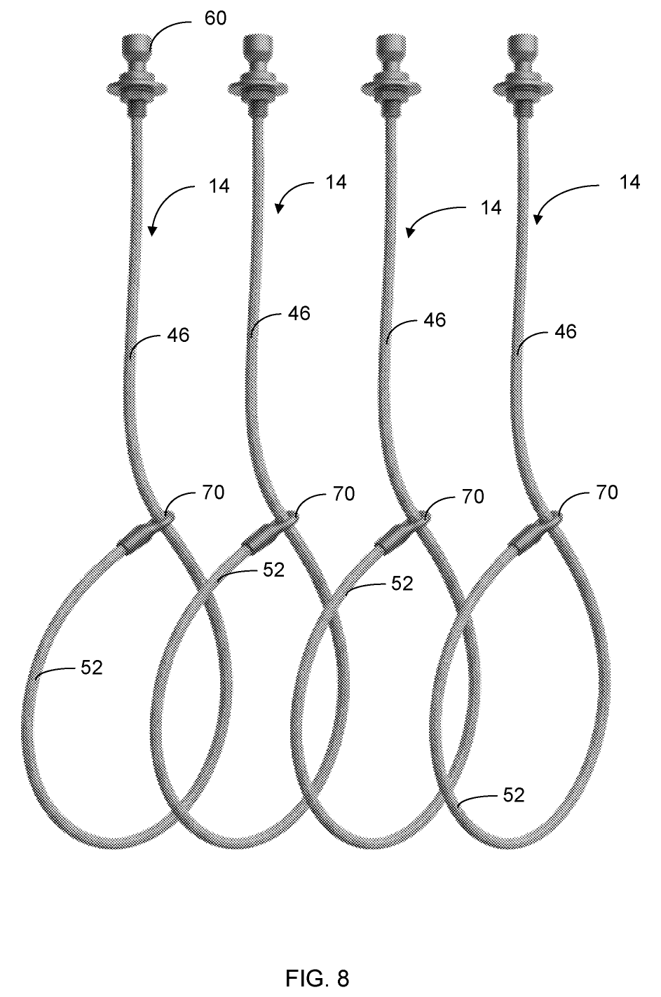

FIG. 8 illustrates four ball-end retention assemblies 14 shown side by side. Each ball-end retention assembly 14 includes a bead lock 60 at an upper end thereof, with the cord 46 extending downwardly from the bead lock 60. The cord 46 of each ball-end retention assembly 14 extends in two legs from the bead lock 60, with the two legs converging at a sliding cinch 70 that forms the slipknot 48. The sliding cinch 70 is slidable along the cord 46 to adjust the size of the loop 52 formed below the sliding cinch 70. The loop 52 of each ball-end retention assembly 14 is configured to encircle the burr portion of a respective one of the plurality of antlers. As shown, the four ball-end retention assemblies 14 have loops 52 of varying sizes, illustrating the independent adjustability of each loop 52 to accommodate antlers of different sizes and to allow the user to achieve a desired hanging height and spacing for each antler displayed on the rail.

The present disclosure is not to be limited to the particular embodiments described herein. In particular, the present disclosure contemplates numerous variations in materials, dimensions, configurations, and attachment mechanisms. The foregoing description has been presented for purposes of illustration and description. It is not intended to be an exhaustive list or limit any of the present disclosure to the precise forms disclosed. It is contemplated that other alternatives or exemplary aspects are considered included in the present disclosure. The description is merely examples of embodiments, processes or methods. It is understood that any other modifications, substitutions, and/or additions can be made, which are within the intended spirit and scope of the invention.

### Additional Options, Variations, and Alternatives

The antler display device can be manufactured in various sizes to accommodate different antler types, from small deer antlers to large elk or moose antlers. The rail may be formed from various materials beyond metal tubing, including aluminum extrusions, composite materials, hardwoods with routed keyhole slots, or reinforced polymers that maintain the necessary strength while providing different aesthetic options. The spacing of keyhole fasteners may vary to accommodate different display preferences, with options for both closely-spaced fasteners for dense displays and widely-spaced arrangements for showcasing individual specimens. Not all keyhole fasteners need be equal distant apart.

Alternative configurations of the ball-end retention assembly may include different cord materials such as leather straps, woven synthetic fibers, coated wire, or decorative ropes that complement various décor styles. The ball terminal may be manufactured in different shapes and materials, including wooden beads, decorative metal finials, or custom-molded designs that enhance the aesthetic appeal of the display. For hunters seeking enhanced security, locking mechanisms may also be incorporated that prevent the ball terminal from being easily removed without a specialized tool. Additionally, the system may be adapted to include supplementary attachment points for displaying accompanying items such as hunting photos, medallions, or information cards about each antler specimen. The rail system may also be configured in non-linear arrangements, such as curved sections or corners, C-shapes, U-shapes, L-shapes, etc. to follow wall contours or create custom display shapes that maximize available space while maintaining the core functionality described herein.

What is claimed is:

1. An antler display device for displaying a plurality of antlers, the device comprising:
a rail configured to be mounted to a surface, the rail comprising a generally rectangular metal tube having a front face, the front face having a plurality of keyhole fasteners formed therein, each keyhole fastener having an entry hole and a retention slot extending downwardly therefrom; and
a plurality of ball-end retention assemblies, each ball-end retention assembly configured to secure a respective one of the plurality of antlers to the rail, each ball-end retention assembly comprising: a cord having a first end and a second end, the cord configured to form an adjustable loop sized to encircle a burr portion of the respective one of the plurality of antlers, the adjustable loop formed by an adjustable cinch configured to tighten the adjustable loop around the burr portion under gravitational loading of the respective one of the plurality of antlers; and a ball terminal connected to the first end of the cord, the ball terminal configured to engage with one of the plurality of keyhole fasteners to secure the respective one of the plurality of antlers to the rail.

2. The antler display device of claim 1, wherein the ball terminal of at least one of the plurality of ball-end retention assemblies comprises a bead lock having an upper portion, a neck extending downwardly from the upper portion, and a flange extending radially outwardly from a lower end of the neck, the neck having a reduced diameter relative to both the upper portion and the flange, and wherein when the bead lock is engaged with one of the plurality of keyhole fasteners, the neck is seated within the retention slot with the flange bearing against an interior surface of the front face below the retention slot and the upper portion bearing against the interior surface of the front face above the retention slot.

3. The antler display device of claim 1, wherein the cord of each ball-end retention assembly comprises paracord.

4. The antler display device of claim 1, wherein the adjustable loop of each ball-end retention assembly is independently adjustable in length to accommodate antlers of different sizes among the plurality of antlers and to allow for customized spacing between the plurality of antlers mounted on the rail and wherein the adjustable cinch comprises a sliding cinch, the sliding cinch being slidable along the cord to adjust a size of the adjustable loop.

5. The antler display device of claim 1, wherein the plurality of keyhole fasteners are arranged linearly along the front face of the rail and wherein each retention slot has a width less than the diameter of the respective entry hole.

6. The antler display device of claim 1, wherein the cords of the plurality of ball-end retention assemblies extend outwardly from the front face and hang downwardly therefrom such that the plurality of antlers hang in a plane spaced apart from and generally parallel to a mounting surface, and wherein positioning the keyhole fasteners on the front face provides clearance between the plurality of antlers and the mounting surface.

7. The antler display device of claim 1, further comprising a decorative cutout formed in the front face of the rail, wherein the decorative cutout and the plurality of keyhole fasteners are visible to a viewer when the rail is mounted to a surface.

8. The antler display device of claim 1, wherein the rail further comprises end caps on opposite ends of the generally rectangular metal tube, and wherein the rail is configured to be mounted directly to a wall or to a wall using at least one bracket.

9. The antler display device of claim 1, wherein the adjustable cinch of each ball-end retention assembly is oriented such that a gravitational load of the respective one of the plurality of antlers acts in a tightening direction on the adjustable cinch, causing the adjustable loop to cinch more tightly around the burr portion of the respective one of the plurality of antlers as the respective one of the plurality of antlers hangs from the rail.

10. The antler display device of claim 1, wherein the burr portion of each of the plurality of antlers has an enlarged diameter relative to a main beam of the respective one of the plurality of antlers, and wherein the adjustable loop of each ball-end retention assembly encircles the burr portion such that the enlarged diameter of the burr portion prevents the adjustable loop from migrating along the main beam of the respective one of the plurality of antlers.

11. The antler display device of claim 1, wherein the cord of each ball-end retention assembly extends through a ferrule and through the ball terminal and terminates in a knot on a side of the ball terminal opposite the ferrule, such that the ferrule and the knot cooperate to prevent the cord from separating from the ball terminal under gravitational loading of the respective one of the plurality of antlers.

12. An antler display device for displaying a plurality of antlers, the device comprising:
a rail comprising a generally rectangular metal tube having a front face, a plurality of keyhole fasteners formed in the front face, each keyhole fastener having an entry hole and a retention slot extending downwardly therefrom, and a decorative cutout formed in the front face;
a plurality of ball-end retention assemblies, each ball-end retention assembly configured to secure a respective one of the plurality of antlers to the rail, each ball-end retention assembly comprising: a cord having a first end and a second end, the cord configured to form an adjustable loop sized to encircle a burr portion of the respective one of the plurality of antlers, the adjustable loop formed by an adjustable cinch configured to tighten the adjustable loop around the burr portion under gravitational loading of the respective one of the plurality of antlers; and
a ball terminal connected to the first end of the cord, the ball terminal having a diameter greater than a width of the retention slot and less than or equal to a diameter of the entry hole, the ball terminal configured to be inserted through the entry hole and retained within the retention slot to secure the respective one of the plurality of antlers to the rail;
wherein the cords of the plurality of ball-end retention assemblies extend outwardly from the front face and hang downwardly therefrom such that the plurality of antlers hang spaced apart from a mounting surface.

13. The antler display device of claim 12, wherein the rail is configured to be mounted directly to a wall or to a wall using at least one bracket.

14. The antler display device of claim 12, wherein the cord of each ball-end retention assembly comprises paracord.

15. The antler display device of claim 12, wherein at least two of the plurality of ball-end retention assemblies have adjustable loops of different lengths such that respective ones of the plurality of antlers are suspended at different heights relative to the rail.

16. The antler display device of claim 12, wherein the ball terminal of at least one of the plurality of ball-end retention assemblies comprises a bead lock having an upper portion, a neck extending downwardly from the upper portion, and a flange extending radially outwardly from a lower end of the neck, the neck having a reduced diameter relative to both the upper portion and the flange, and wherein when the bead lock is engaged with one of the plurality of keyhole fasteners, the neck is seated within the retention slot with the flange bearing against an interior surface of the front face below the retention slot and the upper portion bearing against the interior surface of the front face above the retention slot.

17. The antler display device of claim 12, wherein the burr portion of each of the plurality of antlers has an enlarged diameter relative to a main beam of the respective one of the plurality of antlers, and wherein the adjustable loop of each ball-end retention assembly encircles the burr portion such that the enlarged diameter of the burr portion prevents the adjustable loop from migrating along the main beam of the respective one of the plurality of antlers.

18. The antler display device of claim 12, wherein the cord of each ball-end retention assembly extends through a ferrule and through the ball terminal and terminates in a knot on a side of the ball terminal opposite the ferrule, such that the ferrule and the knot cooperate to prevent the cord from separating from the ball terminal under gravitational loading of the respective one of the plurality of antlers.

19. The antler display device of claim 12, wherein the decorative cutout and the plurality of keyhole fasteners are formed in the front face in a single manufacturing operation.

20. The antler display device of claim 12, wherein the plurality of antlers comprises deer antlers, elk antlers, shed antlers, or combinations thereof, each secured to the rail by a respective one of the plurality of ball-end retention assemblies with the adjustable loop of the respective ball-end retention assembly cinched around the burr portion of the respective one of the plurality of antlers such that each of the plurality of antlers hangs downwardly from the rail with tines of each of the plurality of antlers projecting outwardly away from the mounting surface.
